(19) United States
(12) Patent Application Publication
(10) Pub. No.: US 2015/0375609 A1
(43) Pub. Date: Dec. 31, 2015

(54) RETARDER ARRANGEMENT FOR ELECTRIC DRIVE SYSTEM

(71) Applicant: Caterpillar Inc., Peoria, IL (US)

(72) Inventor: Saeid Mirzaei, Muskego, WI (US)

(73) Assignee: Caterpillar Inc., Peoria, IL (US)

(21) Appl. No.: 14/848,435

(22) Filed: Sep. 9, 2015

(51) Int. Cl. B60K 6/22; B60P 1/04

(52) U.S. Cl. CPC B60K 6/22; B60P 1/04; Y10S 903/902

(57) ABSTRACT

The present disclosure is related to a machine which includes a chassis, a dump body supported to the chassis, and an electric drive system. The electric drive system includes an engine, a generator connected to the engine, a rectifier electrically connected to the generator, an inverter electrically connected to the rectifier, an electric motor electrically connected to the inverter, and a retarder arrangement configured to receive current from the inverter while a brake is applied. Further, the retarder arrangement includes a resistor grid configured to dissipate heat when the current is received from the inverter while the brake is applied. Moreover, the resistor grid is disposed inside an oil bath provided underneath the dump body.

### TECHNICAL FIELD

The present disclosure relates to an electric drive system associated with a machine, and more particularly to a retarder arrangement of the electric drive system.

### BACKGROUND

Various machines which are commonly used in mining, heavy construction, quarrying, and other applications have an electric drive systems. The electric drive system for a machine typically includes a power circuit that selectively activates one or more electric motors. The electric motors are drivably connected to wheels or other traction devices that are used to propel the machine. The electric drive system includes a prime mover, for example, an internal combustion engine, that drives a generator. Alternatively, the electric drive system may include a power line system, such as a trolley system to receive an electric power. The generator produces electrical power that is used to propel the machine via the power circuit. During the propulsion of the machine, the mechanical power produced by the prime mover is converted to electrical power by the generator. This electrical power is further conditioned before it is supplied to the electric motors. The electric motors convert the electrical power back into mechanical power to drive the wheels and propel the machine.

The electric drive system may also include an electric retarder arrangement. The retarder arrangement retards the machine when the operator desires to decelerate the machine. As the machine decelerates, the momentum of the machine is transferred to the electric motor via rotation of the wheels. The electric motor acts as a generator to convert the kinetic energy of the machine to electrical power that is supplied to the electric drive system. This electrical energy may be dissipated through wasting, storage, or other consumption by the system in order to absorb the machine's kinetic energy. The retarder arrangement typically includes a series of resistors through which heat is dissipated when electrical energy passes thereby. There are also cooling system to facilitate the heat dissipation, for example, by forced convection by use of a fan.

U.S. Patent Published Application Number 2012/0169109, hereinafter referred as the '109 patent, describes a system and a method for heating a dump body. The heated dump body comprises a floor including one or more bolsters formed within the floor. The dump body further includes a pair of side sheets, each of the side sheets coupled to one side of the floor, each of the pair of side sheets including one or more bolsters formed within each respective side sheet. The dump body further includes a front sheet coupled to the floor and the side sheets, the front sheet including one or more bolsters formed within the front sheet. The dump body also includes a canopy coupled to the front sheet, the canopy including one or more bolsters formed within the canopy. The bolsters formed in the floor, the pair of side sheets, the front sheet and the canopy are each operable to channel air. However, the '109 patent publication describes the system and method for heating the dump body with a blower and is not energy efficient. Also, the '109 patent describes a dump body with a specific design for channelizing air for heating purposes.

### SUMMARY OF THE DISCLOSURE

In one aspect of the present disclosure, a machine comprises a chassis, a dump body supported by a chassis, and an electric drive system. The electric drive system includes an engine, a generator connected to the engine, a rectifier electrically connected to the generator, an inverter electrically connected to the rectifier, an electric motor electrically connected to the inverter, and a retarder arrangement configured to receive current from the inverter when a brake is applied. Further, the retarder arrangement includes a resistor grid configured to dissipate heat when the current is received from the inverter when the brake is applied. Moreover, the resistor grid is disposed inside an oil bath provided underneath the dump body.

Other features and aspects of this disclosure will be apparent from the following description and the accompanying drawings.

### BRIEF DESCRIPTION OF THE DRAWINGS

FIG. 1 is a perspective view of an exemplary machine having an electric drive system disposed with an electric retarding system, according to an embodiment of the present disclosure;

FIG. 2 is a block diagram of the electric drive system, according to an embodiment of the present disclosure;

FIG. 3 is a bottom perspective view of a dump body of the machine of FIG. 1, according to an embodiment of the present disclosure; and

FIG. 4 is a bottom perspective view of a dump body of the machine of FIG. 1, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

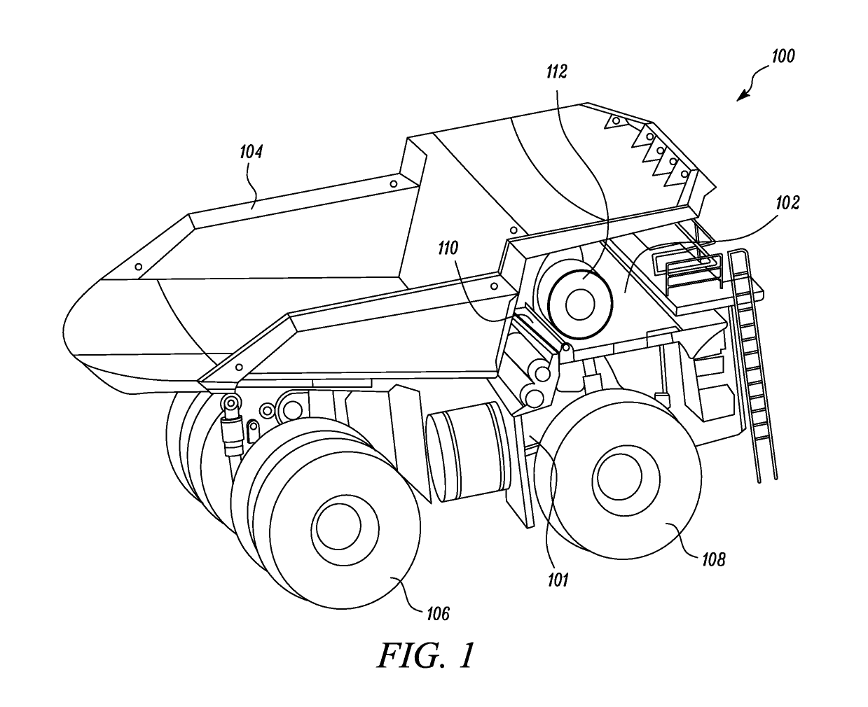

Referring to FIG. 1, a perspective view of an exemplary machine 100 is illustrated according to an embodiment of the present disclosure. The term “exemplary machine,” therefore, is used to generically describe any machine having at least one drive wheel driven by an electric motor connected thereto and a dump body arranged to carry payload. Electrical power may be generated onboard by a generator, alternator, or any another power-generation device, which may be driven by an engine or another prime mover. The electrical power may be stored but not generated onboard. Alternatively, the electrical power may be received from a power line system, such as a trolley system. As shown in FIG. 1, the machine 100 is a mining truck with an electric drive system (not shown).

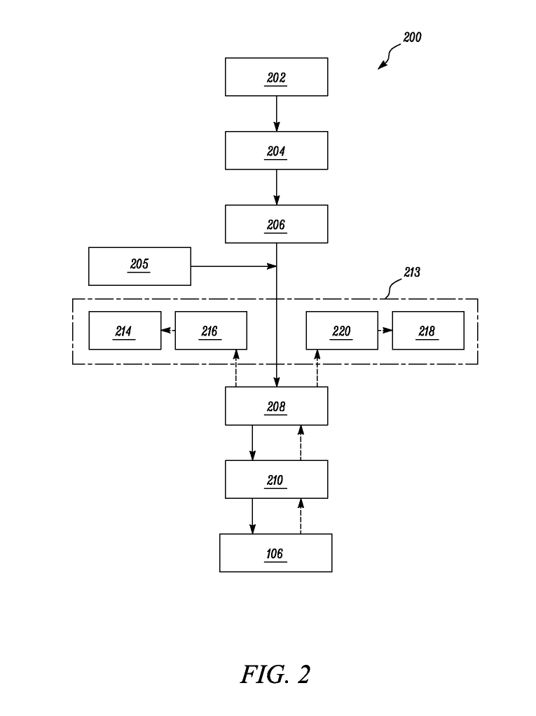

The machine 100 includes a chassis 101 that supports an operator cab 102 and a dump body 104. The dump body 104 is pivotally connected to the chassis 101 and is arranged to carry a payload when the machine 100 is in service. An operator occupying the operator cab 102 can control the motion and various other functions of the machine 100. The chassis 101 is also connected to various drive system components. These drive system components are capable of driving a set of drive wheels 106 to propel the machine 100. Further, a set of idle wheels 108 can be used to steer, such that the machine 100 can move in a direction. Even though the machine 100 includes a rigid chassis 101 with the drive wheels 106 to propel the machine 100 and the idle wheels 108 to steer the machine 100, one can appreciate that other machine configurations can be used. For example, such configurations may include an articulated chassis with one or more drive wheels. Further, the machine 100 includes an electric drive system. In an exemplary embodiment, FIG. 2 illustrates a block diagram of the electric drive system 200 of the machine 100

As shown in FIG. 2, in the electric drive system 200 a flow of power, when the machine 100 is propelled, is denoted by solid-lined arrows. On the other hand, the flow of power during a retarding mode is denoted by dash-lined arrows. In an exemplary embodiment, the electric drive system 200 includes an engine 202, for example, an internal combustion engine such as a diesel engine, which produces an output torque at an output shaft (not shown). The engine 202 may be of various configurations, such as in-line or V-type. The output shaft of the engine 202 is connected to a generator 204. In operation, the output shaft of the engine 202 rotates a rotor of the generator 204 to produce electrical power, for example, in the form of an alternating current (AC power). AC power is supplied to a rectifier 206 and converted to direct current (DC power). The rectified DC power may be converted again to AC power by an inverter circuit 208. In another embodiment, the DC power may also be received from a power line system 205 like a trolley system and further converted to AC power by an inverter circuit 208. The inverter circuit 208 may be capable of selectively adjusting the frequency and/or pulse-width of its output, such that electric motors 210 that are connected to the output of the inverter circuit 208 may be operated at variable speeds and torques. The electric motors 210 may be connected via final assemblies (not shown) or directly to the drive wheels 106 of the machine 100.

During the propulsion of the machine 100, the engine 202 generates mechanical power that is converted into electrical power, which is conditioned by various electrical components. In an illustrated embodiment, such components are housed within a cabinet 110 (see FIG. 1). The cabinet 110 is disposed on the chassis 101 or a platform which is adjacent to the operator cab 102 and may house the rectifier 206, the inverter circuit 208, and/or other components of the electric drive system 200. When the machine 100 is to be decelerated or its motion is otherwise to be retarded, for example, to prevent acceleration of the machine 100 while travelling down an incline, kinetic energy of the drive wheels 106 is converted back to electrical energy. Effective disposition of this generated electrical power enables effective retarding of the machine 100.

During the retardation of the machine 100, the electric motors 210 may act as electrical generators. The electrical power generated by the electric motors 210 has an AC waveform. In an embodiment, the inverter circuit 208 may be a bridge inverter, such that power supplied by the electric motors 210 may be rectified by the inverter circuit 208 and converted into DC power. Further, dissipation of DC power generated by the electric motors 210 produces a counter-rotational torque at the drive wheels 106 to decelerate the machine 100. Dissipation of DC power may be accomplished by passing the rectified current by the inverter circuit 208 through a set of resistors. In an embodiment, a retarder arrangement 213 is provided and it may include a first resistor grid 214, described in greater detail below, which is arranged to receive the rectified current from the inverter circuit 208 via a switch 216. When the switch 216 is closed, the DC power corresponding to the current generated by the electric motors 210 may pass through the first resistor grid 214 and is dissipated as heat. Additionally, an excess DC power is also dissipated as heat as it passes through a second resistor grid 218, which is arranged to receive DC power via a chopper circuit 220. The chopper circuit 220 operates to selectively route a portion of the developed DC power through the second resistor grid 218.

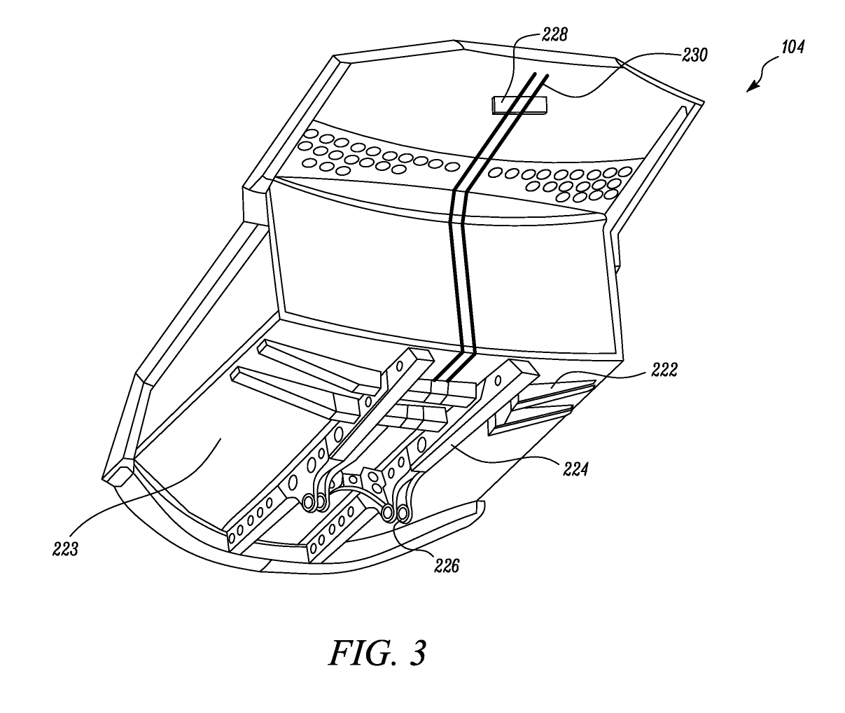

FIG. 3 is a bottom view of the dump body 104 of the machine 100. According to an embodiment of the present disclosure, one or more oil bath tubes 222 are arranged transversely on a bottom surface 223 of the dump body 104. The oil bath tubes 222 are filled with oil. In another embodiment, the oil bath tubes 222 may be arranged longitudinally on the bottom surface 223 of the dump body 104. In yet another embodiment, the oil bath tubes 222 may also have a longitudinal as well as a transverse arrangement on the bottom surface 223 of the dump body 104. The bottom surface 223 of the dump body 104 also includes a frame 224 which may be used for pivotally connecting the dump body 104 with the chassis 101 at pivoting points 226. Further, the oil bath tubes 222 and the frame 224 are also attached or welded together. The oil bath tubes 222 have cavities inside which oil, for example silicone oil e.g. siloxanes, is filled.

According to an embodiment of the present disclosure, in the retarder arrangement 213, which includes first resistor grid 214 and second resistor grid 218, at least one of the resistor grids 214 or 218 of both may be located in the oil bath tubes 222 disposed on the bottom surface 223 of the dump body 104. In an embodiment, the second resistor grid 218 is located in the oil bath, which is arranged to selectively receive DC power via the chopper circuit 220 during the retardation of the machine 100. In this configuration, the DC power is dissipated as heat as it passes through the second resistor grid 218. The DC power may be determined by electronic control unit (ECU). The determination may be based on the machine 100 to retard faster than the usual retardation. In this embodiment, when a brake is applied the inverter circuit 208 passes current to the second resistor grid 218 through the contactors 228. The contactors 228 selectively pass electric current to the resistor grids of the retarder arrangement 213 via power cable 230. In another embodiment, any number of the resistor grids may be disposed in the oil bath tubes 222 on the bottom surface 223 of the dump body 104. In yet another embodiment, at least one of the resistor grids 214 or 218 may be located in a blower housing 112 (shown in FIG. 1) for forced convection cooling.

The electric current when passes through the second resistor grid 218 the heat is dissipated. The dissipated heat will transfer the thermal energy into the oil bath tubes 222 to heat the oil present in the oil bath tubes 222. The oil bath tubes 222 disposed over the bottom surface 223 of the dump body 104 will heat the dump body 104 and the dump body 104 will act as a heat sink. The material present in the dump body 104 will be heated and the warm material will not get stuck on the walls of the dump body 104. The temperature rise will depend on various parameters. These parameters may include weight of the dump body 104, heat capacity, number of resistor grids, etc. The values of these parameters may help the operator to calculate the time required to increase the temperature of some value.

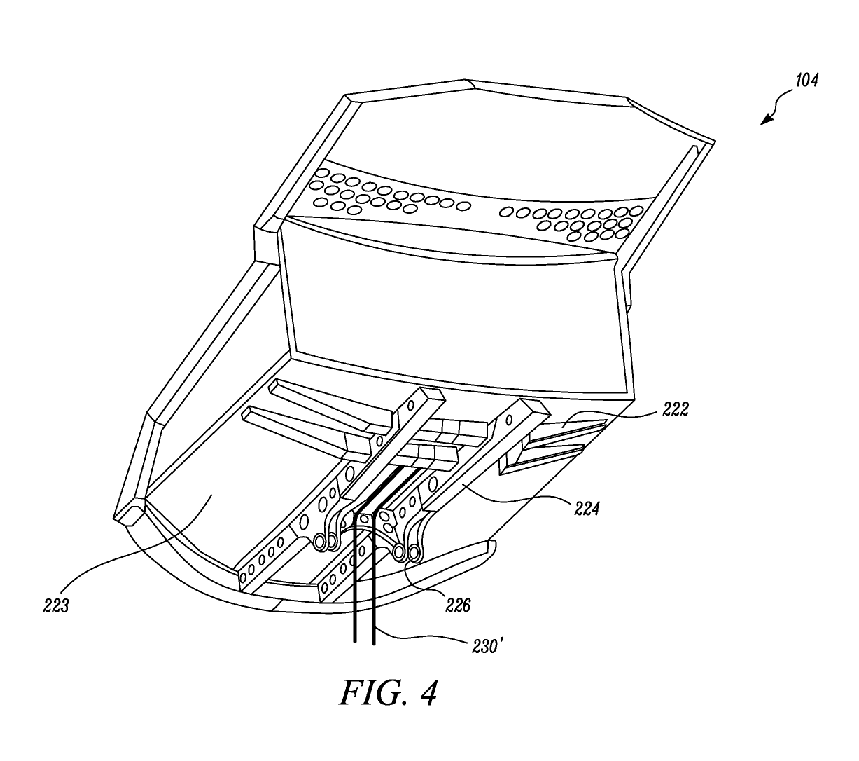

FIG. 4 is a bottom view of a dump body 104 of the machine 100, according to another embodiment of the present disclosure. As illustrated, one or more oil bath tubes 222 are arranged transversely on a bottom surface 223 of the dump body 104. The oil bath tubes 222 are filled with oil. In another embodiment, the oil bath tubes 222 may be arranged longitudinally on the bottom surface 223 of the dump body 104. In yet another embodiment, the oil bath tubes 222 may also have a longitudinal as well as a transverse arrangement on the bottom surface 223 of the dump body 104. The bottom surface 223 of the dump body 104 also includes a frame 224 which may be used for pivotally connecting the dump body 104 with the chassis 101 at pivoting points 226. Further, the oil bath tubes 222 and the frame 224 are also attached or welded together. The oil bath tubes 222 have cavities inside which oil, for example silicone oil e.g. siloxanes, is filled.

According to an embodiment of the present disclosure, in the retarder arrangement 213, which includes first resistor grid 214 and second resistor grid 218 respectively, at least one of the resistor grids 214 or 218 of both may be located in the oil bath tubes 222 disposed on the bottom surface 223 of the dump body 104. In an embodiment, the second resistor grid 218 is located in the oil bath, which is arranged to selectively receive DC power via the chopper circuit 220 during the retardation of the machine 100. In this configuration, the DC power is dissipated as heat as it passes through the second resistor grid 218. The DC power may be determined by electronic control unit (ECU). The determination may be based on the machine 100 to retard faster than the usual retardation. In this embodiment, when a brake is applied the inverter circuit 208 passes DC power to the second resistor grid 218 directly through the power cables 230′. The electric current passes directly to the second resistor grid 218 and the heat is dissipated. The dissipated heat will transfer the thermal energy into the oil bath tubes 222 to heat the oil present in the oil bath tubes 222. The oil bath tubes 222 disposed over the bottom surface 223 of the dump body 104 will heat the dump body 104 and the dump body 104 will act as a heat sink. In another embodiment, any number of the resistor grids may be disposed in the oil bath tubes 222 on the bottom surface 223 of the dump body 104. In yet another embodiment, at least one of the resistor grids 214 or 218 may be located in a blower housing 112 (shown in FIG. 1) for forced convection cooling.

The electric current when passes through the second resistor grid 218 the heat is dissipated. The dissipated heat will transfer the thermal energy into the oil bath tubes 222 to heat the oil present in the oil bath tubes 222. The oil bath tubes 222 disposed over the bottom surface 223 of the dump body 104 will heat the dump body 104 and the dump body 104 will act as a heat sink. The material present in the dump body 104 will be heated causing the warm material not to adhere to the walls of the dump body 104. The temperature rise of dump body 104 will depend on various parameters. These parameters may include weight of the dump body 104, heat capacity of dump body 104, number of resistor grids, etc.

In an exemplary embodiment of the present disclosure, mass of the dump body 104 is determined by m (kg), iron specific heat capacity is determined by c (J/(kg.° C.)), final temperature of the dump body 104 at an end of retarding is determined by Tf (° C.), initial temperature of the dump body 104 at the beginning of retarding is determined by Ti (° C.), the difference in temperature between the final temperature of the dump body 104 at an end of retarding and the initial temperature of the dump body 104 at the beginning of retarding is determined by ΔT (° C.), and the heat energy is determined by Q (J/° C.). Thus, a mathematical model to determine the time required to increase the temperature of the dump body 104 is defined by the following equation:

Q=mc ΔT(J/° C.)

### INDUSTRIAL APPLICABILITY

The present disclosure relates to a machine with an electric drive system which includes a retarder arrangement. The retarder arrangement positioned on the bottom surface of the dump body 104 will make space for other modules like Pump Electronic Tank Unit, Clean Emissions Module such as Selective Catalytic Reduction system, Diesel Particulate Filter, etc., The retarder arrangement is heavy and needs a lot of space on the machine. The arrangement disclosed in the present disclosure will enable to free more space for other modules for machines. The free space may also be utilized for additional retarder arrangement and thus work on high altitude without updating the system software for derating.

The resistor grids are disposed inside the oil bath tube 222 placed on the bottom surface 223 of the dump body 104. When a brake is applied the inverter circuit 208 passes current to the first resistor grid 214 and second resistor grid 218 respectively and the heat is dissipated. The thermal energy is transferred to the oil filled in the oil bath tubes 222. Oil is typically a good conductor of heat and a good insulator of electricity and thus isolates the grid resistors electrically and transfers the heat to the dump body 104. The dump body 104 acts a huge heat sink and cools down the grid resistors without the use of a blower. The heated dump body 104 will enable the material to be warm and will prevent the sticking of warm material to the dump body 104. In the embodiment as described above in FIG. 3, contactors selectively pass electric current to the resistor grids of the retarder arrangement via power cables which are short in length. Further, in another embodiment, as described above in FIG. 4, the inverter circuit passes DC power to the second resistor grid directly through the power cables without any contactors placed over on the dump body 104, thus avoiding movable contact issues.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A machine comprising:
a chassis;
a dump body supported by the chassis; and
an electric drive system including:
an engine;
a generator connected to the engine;
a rectifier electrically connected to the generator;
an inverter electrically connected to the rectifier;
an electric motor electrically connected to the inverter; and
a retarder arrangement configured to receive current from the inverter while a brake is applied, the retarder arrangement including:
a resistor grid configured to dissipate heat when the current is received from the inverter while the brake is applied, wherein the resistor is disposed inside an oil bath provided underneath the dump body.
